(19) United States
(12) Patent Application Publication
(10) Pub. No.: US 2013/0206387 A1
(43) Pub. Date: Aug. 15, 2013

(54) COMMUNICATING POWER AND DATA TO A COMPONENT IN A WELL

(71) Applicants: Benoit Deville, Saint-Germain-En-Laye (FR); Marian Faur, Massy (FR); Charley Martinez, Moissy Cramayel (FR)

(72) Inventors: Benoit Deville, Saint-Germain-En-Laye (FR); Marian Faur, Massy (FR); Charley Martinez, Moissy Cramayel (FR)

(73) Assignee: SCHLUMBERGER TECHNOLOGY CORPORATION, Sugar Land, TX (US)

(21) Appl. No.: 13/397,078

(22) Filed: Feb. 15, 2012

(51) Int. Cl. E21B 4/04; G01V 3/00; E21B 43/00

(52) U.S. Cl. 166/66.4; 166/66; 340/853.1; 340/854.9

(57) ABSTRACT

An apparatus includes a circuit to receive power and data over a communication medium, where the circuit is to separate the power and the data. An electronic switch couples the power output by the circuit to a downhole electrical component for use in a well. According to other implementations, an electro-hydraulic actuator includes an outer housing defining a first hydraulic chamber and a second hydraulic chamber, where a seal for one of the hydraulic chambers is achieved without use of an elastomeric seal.

### BACKGROUND

A well can be drilled into a subterranean structure for the purpose of recovering fluids from a reservoir in the subterranean structure. Examples of fluids include hydrocarbons, fresh water, or other fluids. Alternatively, a well can be used for injecting fluids into the subterranean structure.

Once a well is drilled, completion equipment can be installed in the well. Examples of completion equipment include a casing or liner to line a wellbore. Also, flow conduits, flow control devices, pumps, and other equipment can also be installed to perform production or injection operations.

### SUMMARY

In general, according to some implementations, an apparatus includes a circuit to receive power and data over a communication medium, where the circuit is to separate the power and the data. An electronic switch couples the power output by the circuit to a downhole electrical component (a pump and/or an electro-hydraulic actuator) for use in a well. According to other implementations, an electro-hydraulic actuator includes an outer housing defining a first hydraulic chamber and a second hydraulic chamber, where a seal for one of the hydraulic chambers is achieved without use of an elastomeric seal.

Other features will become apparent from the following description, from the drawings, and from the claims.

### BRIEF DESCRIPTION OF THE DRAWINGS

Some embodiments are described with respect to the following figures:

FIG. 1 illustrates an example arrangement of equipment for use with a well, according to some implementations;

FIGS. 2, 5-7, 9, and 10 are schematic diagrams of example arrangements including a shared communication medium for delivering power and data to downhole electrical modules, in accordance with some implementations;

FIGS. 3 and 8 are schematic diagrams of portions of the example arrangements of FIGS. 2 and 7, according to some implementations;

FIG. 4 is a schematic diagram of a bidirectional triode thyristor for use in a downhole electrical module according to some implementations;

FIGS. 11, 13, and 15 are schematic diagrams of electro-hydraulic actuators according to various implementations; and

FIGS. 12 and 14 are hydraulic diagrams of the arrangements of FIGS. 11 and 13, respectively.

### DETAILED DESCRIPTION

As used here, the terms “above” and “below”; “up” and “down”; “upper” and “lower”; “upwardly” and “downwardly”; and other like terms indicating relative positions above or below a given point or element are used in this description to more clearly describe some embodiments. However, when applied to equipment and methods for use in wells that are deviated or horizontal, such terms may refer to a left to right, right to left, or diagonal relationship as appropriate.

Various types of components for use in a well can perform electrical communications and can be powered by electrical power. In some examples, a surface unit (located at an earth surface above a well) can include a telemetry module to perform data communication and one or more power supplies to provide power to downhole electrical components. In some examples, the surface unit can include a main power supply (e.g. a main AC or alternating current power supply) and an auxiliary power supply (e.g. an auxiliary AC power supply). The main power supply can be used to deliver power to certain components of a downhole tool, such as sensors, flow control devices, and so forth. The auxiliary power supply can be used to power other components, such as a pump (e.g. electro-hydraulic pump, solenoid pump, piezoelectric pump, and shape memory alloy pump) or an electro-hydraulic actuator. In some examples, separate electrical lines are used to provide power from the main power supply and the auxiliary power supply to corresponding downhole electrical components. Use of separate power supplies, such as the main power supply and the auxiliary power supply, and corresponding separate electrical lines, can be complex and inefficient. For example, use of the separate electrical lines can result in a larger number of electrical connections, which can lead to reduced reliability and increased rig time (time involved in assembling and deploying a tool string at a well site).

In accordance with some embodiments, instead of using separate electrical lines to deliver power from separate power supplies to downhole electrical components, a shared communication medium can be used to deliver both power and data to various downhole components (including pumps and/or electro-hydraulic actuators), which can be connected to the shared electrical communication medium in parallel. As discussed in further detail below, the shared communication medium for delivering power and data can include a twisted wire pair or a coaxial cable. The shared communication medium can be used to carry power to both components such as pumps and/or electro-hydraulic actuators, as well as other components in a tool, such as a modem and so forth.

FIG. 1 illustrates an example arrangement that includes equipment (e.g. completion equipment or drilling equipment) deployed in a well 104. The downhole equipment can include electrical modules 118 that are able to communicate (both power and data) over a shared communication medium 116. The shared communication medium 116 extends to earth surface equipment located at an earth surface 102 from which the well 104 extends. The earth surface equipment includes a wellhead 101 and a surface unit 100. The shared communication medium extends through the wellhead 101 to the surface unit 100.

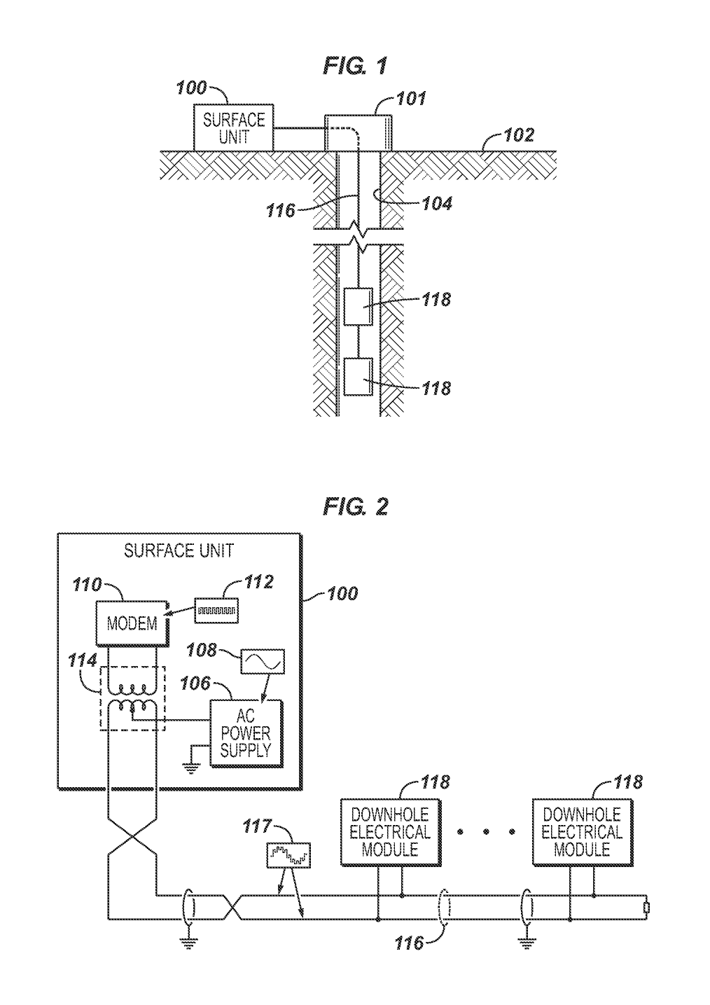

FIG. 2 is a schematic diagram of an example arrangement that includes the surface unit 100, the shared communication medium 116, and the downhole electrical modules 118 (which can include pumps and/or electro-hydraulic actuators). The surface unit 100 includes a power supply 106, which includes an AC power supply that outputs an AC power signal 108.

The surface unit 100 also includes a telemetry module 110, which can be a modem or other type of telemetry module. The telemetry module 110 is used to perform data communication. The telemetry module 110 is able to input or output a data signal 112. The data signal 112 can be received over the shared communication medium 116 by the telemetry module 110 from a downhole component, such as a sensor. In other examples, the data signal 112 can be a command signal or other signal that is output by the telemetry module 110 for delivery to a downhole component.

The AC power signal 108 can have a relatively low frequency, while the data signal 112 can have a relatively high frequency (higher than the frequency of the AC power signal 108).

In the output direction (from the surface unit 100 to a downhole component), the output data signal from the telemetry module 110 and the output AC power signal from the power supply 106 can be combined by modulation transformer 114. The combined power and data (represented as combined signal 117 in FIG. 1) are supplied over the shared communications medium 116, which can be a twisted wire pair in some examples. A twisted wire pair includes a pair of electrical wires, with the electrical wires being twisted to cross each other at various points. As depicted in FIG. 1, the downhole electrical modules 118 are connected in parallel to the shared communication medium 116.

The combined signal 117 includes the AC power signal delivered in common mode over the twisted wire pair. Summing the signals on the electrical wires of the twisted wire pair produces the AC power signal. The data signal in the combined signal 117 is delivered in differential mode over the twisted wire pair—subtracting the signals on the electrical wires of the twisted wire pair produces the data signal.

Note that in the reverse direction, when data signal from a downhole component is communicated uphole to the surface unit 100, the modulation transformer 114 is able to separate the uphole data signal from the combined signal on the twisted wire pair 116 to provide to the telemetry module 110.

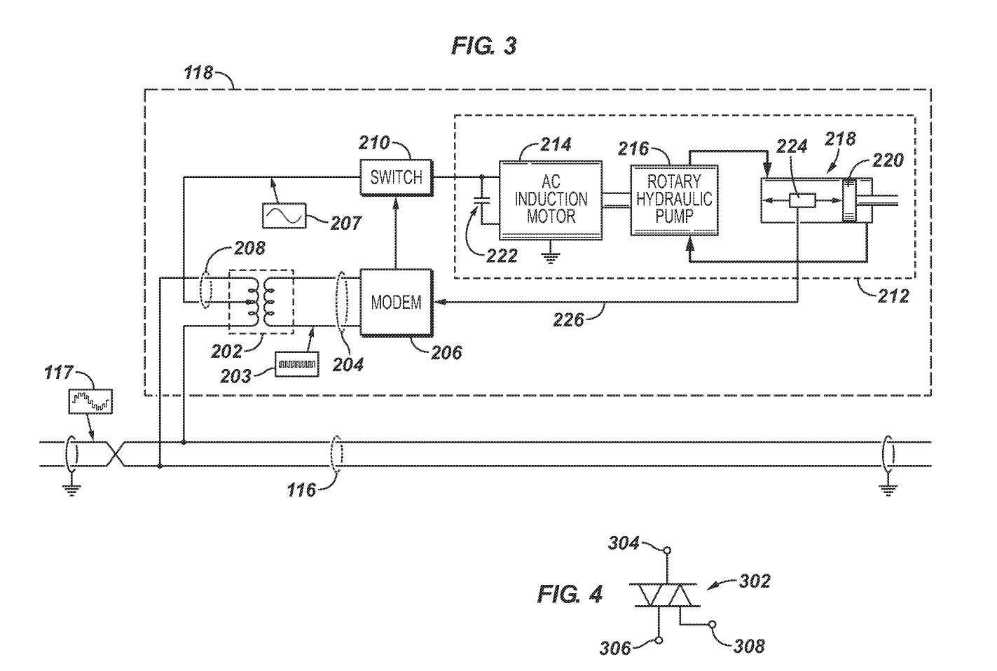

Further details regarding a downhole electrical module 118 according to some examples are depicted in FIG. 3. The electrical module 118 includes a modulation transformer 202 for separating the AC power signal and the data signal from the combined signal 117 on the shared communication medium 116. As noted above, a data signal is carried on the shared communication medium 116 in differential mode, while the AC power signal is carried on the shared communication medium 116 in common mode. The modulation transformer 202 is able to subtract the signals on the wires of the twisted wire pair 116 to produce a data signal 203, which is provided at the output 204 of the modulation transformer 202. The output data signal 203 is provided to a telemetry module 206, which can be a modem in some examples. Note that the output data signal 203 can be a command sent to the downhole electrical module 118 to actuate the module 118. Note also that data signal can also flow in the opposite direction, from the telemetry module 206 through the modulation transformer 202 to the twisted wire pair 116.

The modulation transformer 202 is able to sum the signals on the wires of the twisted wired pair 116 to provide a common mode signal at output 208 in FIG. 3. The common mode signal is the AP power signal 207, which is provided to an input of a switch 210.

The switch 210 is some examples can be an electronic switch, rather than an electro-mechanical relay that can consume relatively large amounts of power. In some examples, the electronic switch 210 is a semiconductor switch that is formed using semiconductor technology. The semiconductor switch can be a bidirectional (bilateral) triode thyristor. An example bidirectional triode thyristor 302 is shown in FIG. 4, which has terminals 304 and 306 and a gate terminal 308. A control signal can be provided to the gate terminal 308 to trigger flow of current between the terminals 304 and 306 through the bidirectional triode thyristor 302. Current can flow in either direction.

In other examples, the electronic switch 210 can include transistor(s), such as power transistor(s) to allow power communication through the electronic switch 210.

The output of the electronic switch 210 is connected to an electrical component 212 that is to be powered by the AC power signal 207 provided through the electronic switch 210. In some examples, the electrical component 212 can be an electro-hydraulic actuator that has a motor 214, a hydraulic pump 216, and an actuator 218 that has a piston 220 moveable by hydraulic pressure created by the hydraulic pump 216. In other examples, other types of electrical components can be powered by power delivered through the electronic switch 210 of FIG. 3.

A capacitor 222 in the electrical component 212 allows for a phase shift to drive the motor 214.

The telemetry module 206 provides an output to the electronic switch 210 (such as to the gate 308 of the thyristor 302 of FIG. 4). The output of the telemetry module 206 can provide a command to the electronic switch 210 to activate or deactivate the electronic switch 210, in response to control signaling received over the shared communication medium 116.

In some examples, the actuator 218 can include a position sensor 224 to measure a position of the piston 220. The measured position can be communicated by the position sensor 224 over communication line 226 to the telemetry module 206, which can provide a data signal representing the measured position through the modulation transformer 202 to the twisted wire pair 116 for communication to the surface unit 100.

Although a specific arrangement is depicted in FIG. 3, note that in other implementations, other arrangements of a downhole electronic module 118 can be used. For example, some of the downhole electronic modules 118 can include electro-hydraulic actuators as discussed above, while others of the downhole electronic modules can include other types of devices, such as sensors, flow control devices, and so forth.

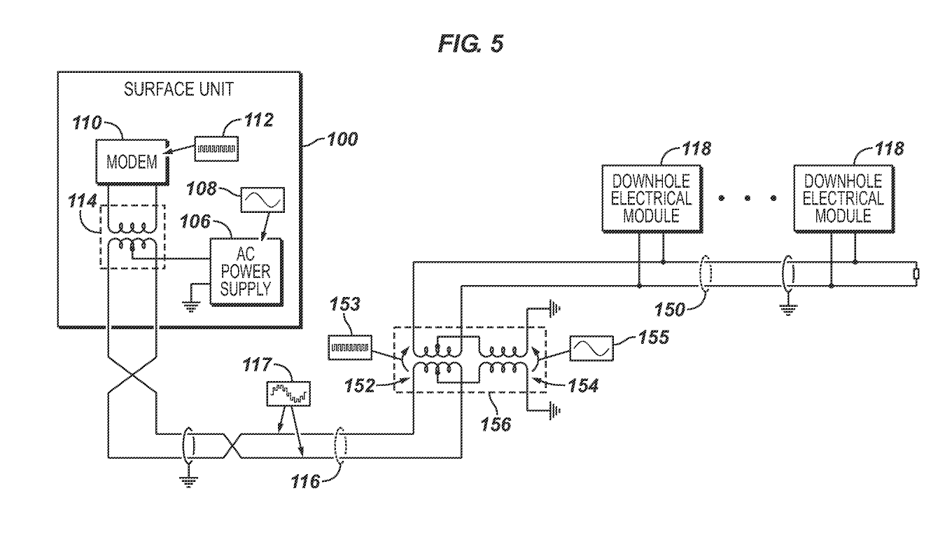

FIG. 5 illustrates an example arrangement that is a variant of the FIG. 2 arrangement. Similar components in FIG. 5 are assigned the same reference numerals as in FIG. 2. In the FIG. 5 arrangement, an inductive coupler 156 (including two pairs 152 and 154 of coils for communicating respective signals 153 and 155, respectively) are provided to allow communication with the shared communication medium 116 (e.g. twisted wire pair) and another shared communication medium 150, without having to provide for electrical connection between the shared communication media 116 and 150.

An inductive coupler performs communication (data and/or power) using induction between the inductive coupler portions (e.g. coils) of the inductive coupler.

The pairs 152 and 154 of coils provide a transformer that is able to perform signal summation (to extract a common-mode signal) and signal subtraction (to provide a differential-mode signal) such that the AC power signal and data signal can be coupled through the inductive coupler 156.

The downhole electrical modules 118 are connected in parallel to the shared communication medium 150. The components of the downhole electrical modules 118 can be similar to those depicted in FIG. 3, for example.

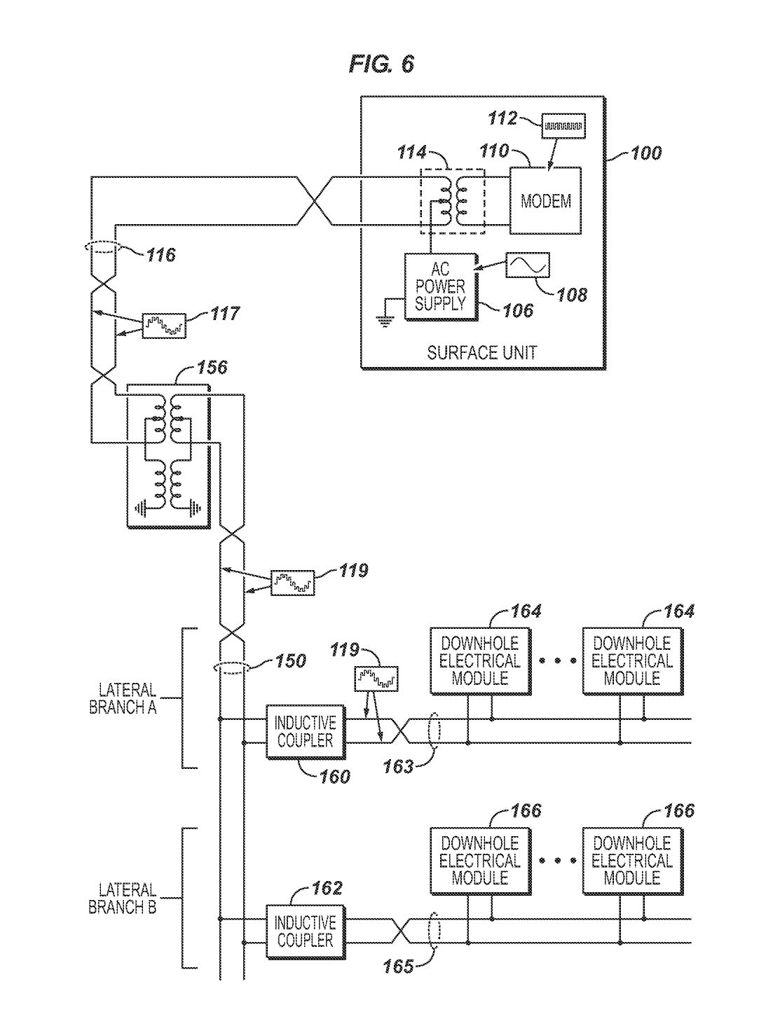

FIG. 6 illustrates an example arrangement that is a variant of the FIG. 5 arrangement. Similar components in FIG. 6 are assigned the same reference numerals as in FIG. 5. The arrangement of FIG. 6 is for use in a multilateral well having lateral branches A and B that extend from a main wellbore. In FIG. 6, the inductive coupler 156 couples data and power between the shared communication media 116 and 150 (e.g. a combined signal 117 is inductively coupled through the inductive coupler 156 and output as a combined signal 119).

In addition, an inductive coupler 160 (similar in design to the inductive coupler 156) is able to inductively couple power and data between the shared communication medium 150 and a shared communication medium 163, which is connected to downhole electrical modules 164 in lateral branch A.

Similarly, an inductive coupler 162 (similar in design to the inductive coupler 156) is able to inductively couple power and data between the shared communication medium 150 and a shared communication medium 165, which is connected to downhole electrical modules 166 in lateral branch B. Deployment of additional inductive couplers would allow for communication of power and data with equipment in additional lateral branches.

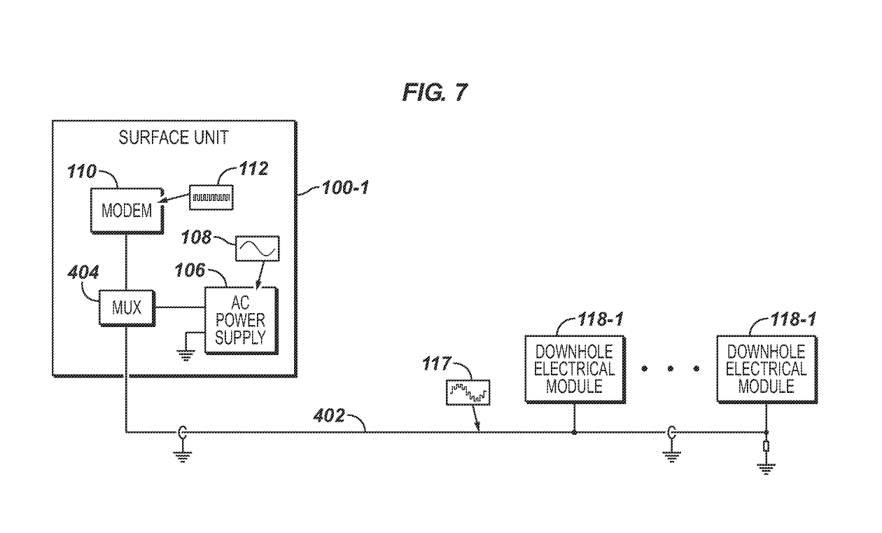

FIG. 7 shows an arrangement according to another example, in which a surface unit 100-1 is coupled over a coaxial cable 402 to electrical modules 118. The coaxial cable 402 can have an internal conductor that is surrounded by a conducting shield. An insulating layer is provided between the conducting shield (which can be a tubular conducting shield) and the inner conductor.

The surface unit 100-1 includes the AC power supply 106 and telemetry module 110. However, instead of a modulation transformer as in the surface unit 100 of FIG. 2, the surface unit 100-1 includes a multiplexer 404 that is able to combine the AC power signal 108 output by the AC power supply 106 and the data signal 112 output by the telemetry module 110 for provision as combined signal 117 over the coaxial cable 402.

Downhole electrical modules 118-1 are connected to the coaxial cable 402 to receive the AC power and data signals communicated over the coaxial cable 402. The coaxial cable 402 can also be used to communicate data signals in the uphole direction from the downhole electrical modules 118 to the surface unit 100-1.

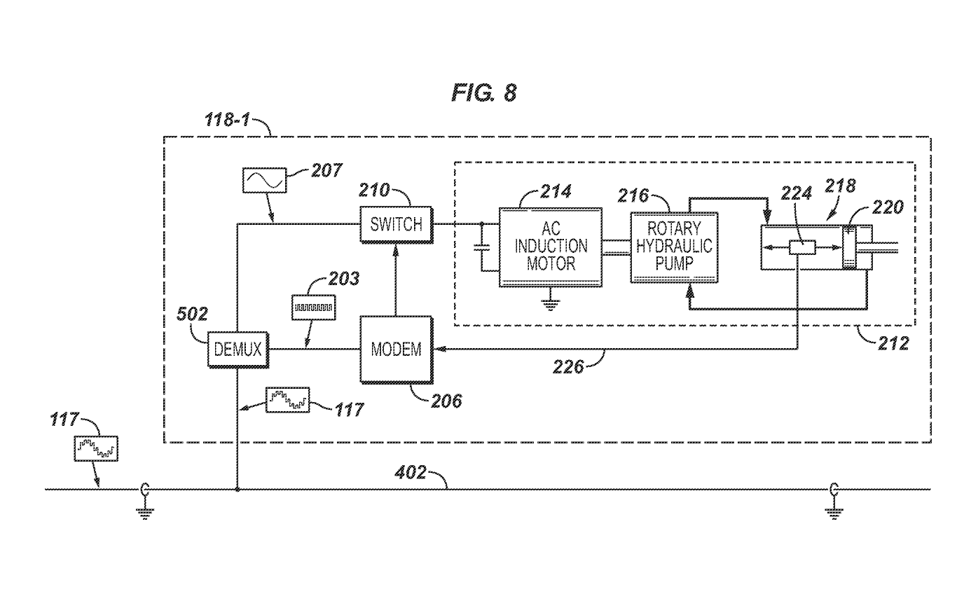

FIG. 8 illustrates example components that can be used in a downhole electrical module 118-1. In the downhole electrical module 118-1, instead of the modulation transformer 202 used in the downhole electrical module 118 of FIG. 3, the downhole electrical module 118-1 includes a demultiplexer to separate high-frequency components (including the data signal 203) from low-frequency components (including the AC power signal 207). In some examples, the demultiplexer 502 can include a high-pass filter to extract high-frequency components, and a low-pass filter to extract low-frequency components.

The data signal 203 output by the demultiplexer 502 is provided to the telemetry module 206, and the AC power signal 207 output by the demultiplexer 502 is provided to the input of the electronic switch 210, which is able to couple the AC power signal 207 to the electrical component 212.

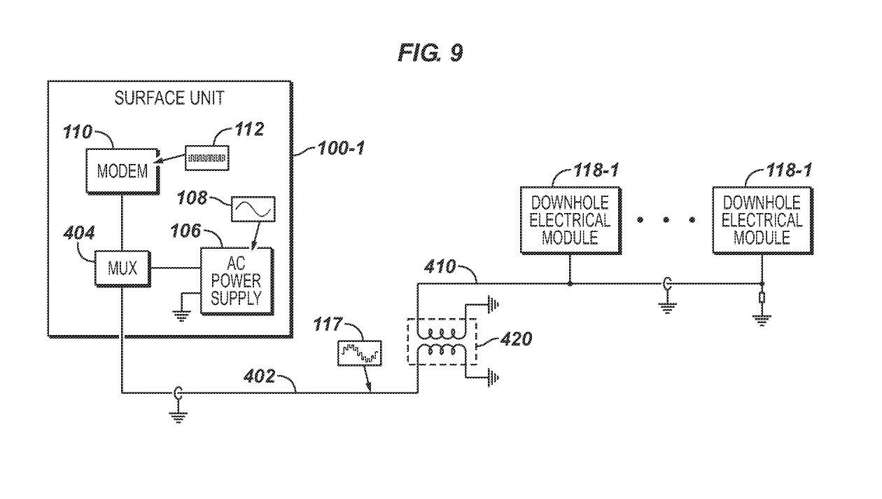

FIG. 9 illustrates an example arrangement that is a variant of the FIG. 7 arrangement. Similar components in FIG. 9 are assigned the same reference numerals as in FIG. 7. The example arrangement of FIG. 9 includes an inductive coupler 420 to inductive power and data signals between the coaxial cable 402 and another coaxial cable 410 that is connected to the downhole electrical modules 118-1.

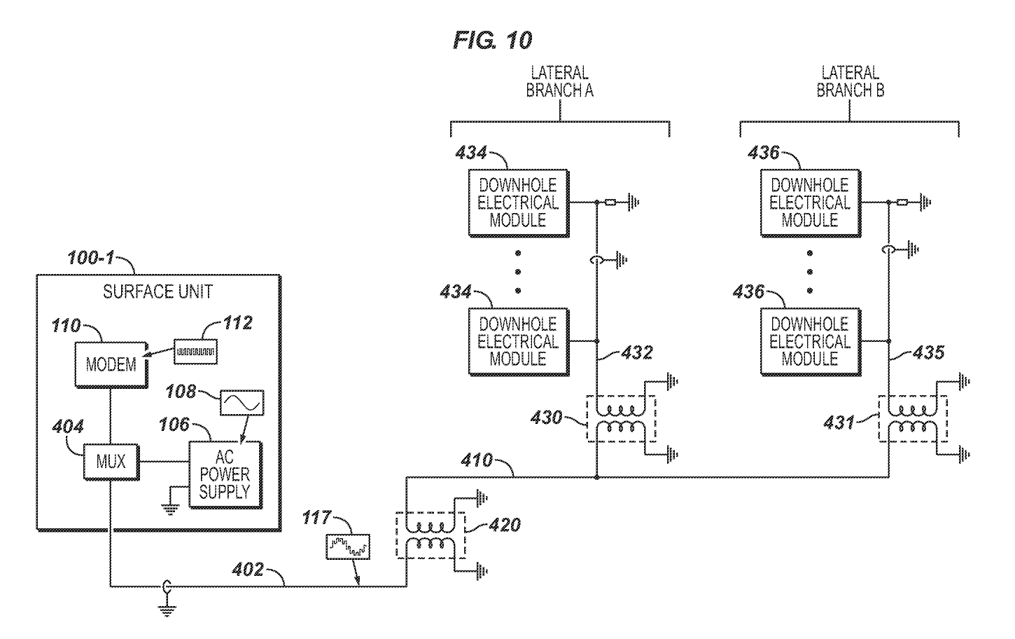

FIG. 10 illustrates an example arrangement that is a variant of the FIG. 9 arrangement. Similar components in FIG. 10 are assigned the same reference numerals as in FIG. 9. The arrangement of FIG. 10 is for use in a multilateral well having lateral branches A and B that extend from a main wellbore. In FIG. 10, the inductive coupler 420 couples data and power between the coaxial cables 402 and 410.

In addition, an inductive coupler 430 (similar in design to the inductive coupler 420) is able to inductively couple power and data between the coaxial cable 410 and a coaxial cable 432, which is connected to downhole electrical modules 434 in lateral branch A.

Similarly, an inductive coupler 431 (similar in design to the inductive coupler 410) is able to inductively couple power and data between the coaxial cable 410 and a coaxial cable 435, which is connected to downhole electrical modules 436 in lateral branch B.

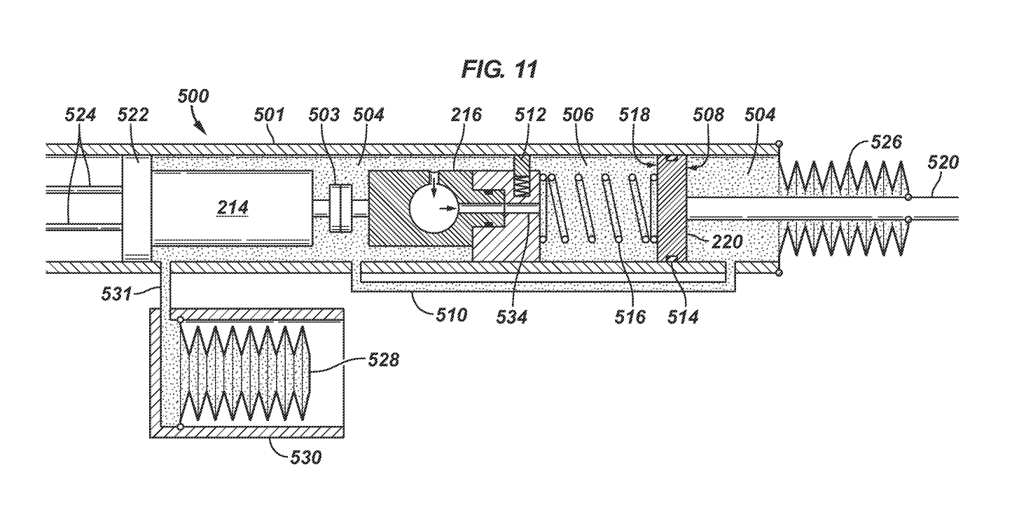

FIG. 11 is a side schematic view of an electro-hydraulic actuator 500, which is an example of the electrical component 212 depicted in FIG. 3 or 8. In accordance with some implementations, the electro-hydraulic actuator 500 does not employ elastomeric seals (either static or dynamic) that are in contact with wellbore fluids. Use of elastomeric seals that are exposed to wellbore fluids in a downhole tool can result in reduced reliability of the tool, since the elastomeric seals may fail at some point over time. Thus, tools that include elastomeric seals that are exposed to wellbore fluids may not be appropriate for use in permanent installations in a well.

The electro-hydraulic actuator 500 has an outer housing 501 (e.g. metal housing), which contains a first chamber 504 and a second chamber 506, which are filled with a hydraulic fluid (the first and second chambers 504 and 506 constitute first and second hydraulic chambers). The first chamber 504 has two parts: a first part on the left of the second chamber 506, and a second part on the right of the chamber 506. The first part of the first chamber 504, which is defined in part by a bulkhead 522, includes the motor 214 and the hydraulic pump 216. Wires 524 extend through the bulkhead 522 to the motor 214.

The second part of the first chamber 504 is adjacent the right side 508 of the piston 220 (which is sealingly engaged due to presence of a seal 514 with the housing 501). A fluid path 510 interconnects the first and second parts of the first chamber 504. In some examples, the fluid path 510 can be provided by a tube welded to the outer housing 502—in other examples, other types of fluid paths can be employed.

When a valve 512 (which can be a solenoid valve or other type of valve) is closed, the second chamber 506 is isolated from the first chamber. Note that an O-ring seal can be provided on the piston 220 to engage an inner surface of the outer housing 502 to provide sealing engagement between the piston 220 and the outer housing 502.

A tension spring 516 is located in the second chamber 506, on the left side 518 of the piston 220. The tension spring 516 tends to pull the piston 220 to the left (in the diagram) and can create sufficient pulling force to place the piston 220 and actuator rod 520 connected to the piston 220 in a first position when pressure is balanced between the first and second chambers 504 and 506. In other examples, instead of using the tension spring 516, a compression spring can be used instead, where the compression spring is placed on the right side 508 of the piston 220.

Since the first chamber 504 is the only one of the two chambers 504 and 506 that potentially is in contact with wellbore fluids, welded metal bellows 526 and 528 can be used to create a fully enclosed first chamber 504. The bellow 526 is welded to the outer housing 502 and the actuator rod 520. The bellow 526 is deformable to allow longitudinal movement of the actuator rod 520 when hydraulically actuated by the pump 216. In other examples, the bellow 526 can have another arrangement.

The bellow 528 is placed in a tubular structure 530, and is welded to the tubular structure 530. One side of the bellow 528 is in fluid communication with the first chamber 504 through fluid path 531. The bellow 528 provides pressure compensation of the first chamber 504 with respect to the external well pressure. The combination of the bellow 528 and the tubular structure 530 provides an equalizing device to equalize the pressure inside the first chamber 504 with the wellbore pressure.

In operation, the motor 502 is activated, such as by use of the electronic switch 210 of FIG. 3 or 8 to couple AC power to the motor 502. The motor 214 is connected to the hydraulic pump 216 by a coupling 503. Activation of the motor 214 causes the hydraulic pump 216 to pump hydraulic fluid through an output path 534 into the second chamber 506, which builds up pressure to move the piston 220. Depending on the applied pressure, an equilibrium position of the piston 220 is reached. The pump 216 allows sufficient pressure to build to cause the piston 220 and the actuator rod 520 to move from the first position to a second position.

To move the piston 220 and actuator rod 520 back from the second position to the first position, the valve 512 can be opened (by use of a command) to allow fluid communication between the first and second chambers 504 and 506, which balances the pressure between the two chambers. Once the pressure in the chambers 504 and 506 are balanced, the tension spring 516 is able to move the piston 220 and actuator rod 520 back to the first position.

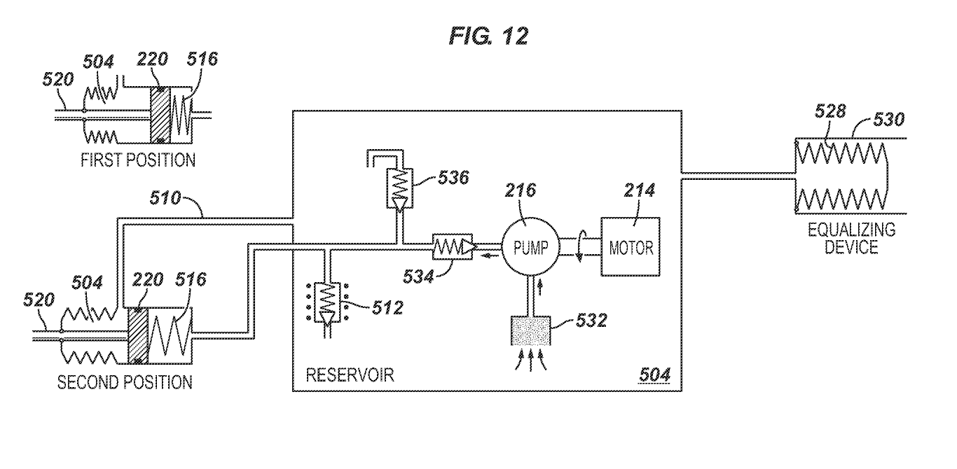

A hydraulic diagram for the arrangement of FIG. 11 is depicted in FIG. 12. Elements in the hydraulic diagram of FIG. 12 that correspond to the elements of FIG. 11 are assigned the same reference numerals. The intake of the pump 216 in FIG. 12 is connected to receive fluid from a fluid reservoir (which is part of the first chamber 504) through a filter 532. A check valve 534 and relief valve 536 are placed at the output of the pump 216 to, respectively, avoid flow back and to control the maximum pressure of the pump 216. Controlling the maximum pressure of the pump 216 allows the amount of power drawn by the motor 214 to be controlled. The first and second positions of the piston 220 and actuator rod 520 are depicted in FIG. 12.

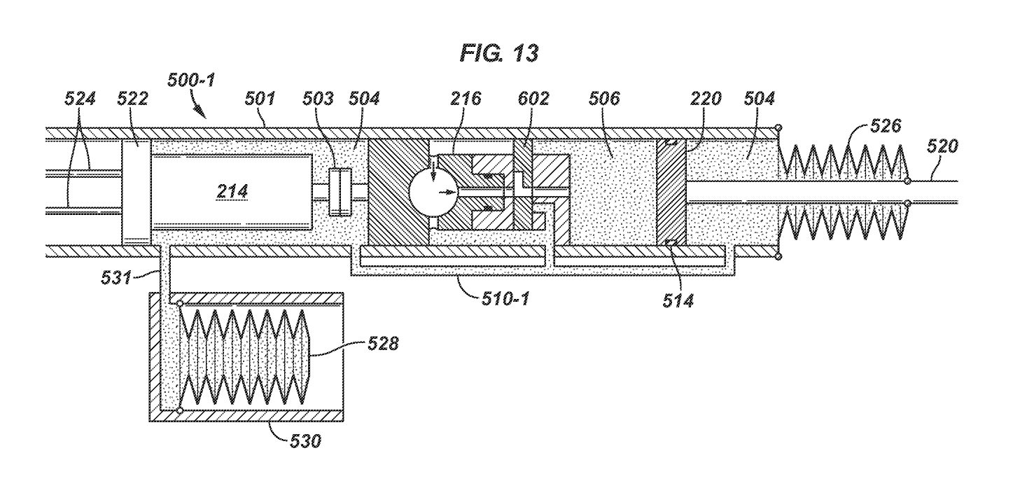

FIG. 13 depicts a different electro-hydraulic actuator 500-1 that does not include the tension spring 516 and valve 512 of FIG. 11. Instead, a hydraulic distributor 602 is used. The components of the electro-hydraulic actuator 500-1 that are similar to the corresponding components of the electro-hydraulic actuator 500 are assigned the same reference numerals.

In the FIG. 13 arrangement, the intake of the pump 216 is not connected to the fluid reservoir, but instead, the fluid reservoir is connected through the first chamber 504 to the pump intake. In FIG. 13, a fluid path 510-1 interconnects the first and second parts of the first chamber 504. In addition, the fluid path 510-1 is connected to an output port of the hydraulic distributor 602.

The hydraulic distributor 602 has two positions. In FIG. 13, the hydraulic distributor 602 is in its top position. In this position, the fluid path from the second chamber 506 to the pump intake is closed, while the fluid path from the right part of the first chamber 504 (on the right of the piston 220 in FIG. 13) and the fluid reservoir to the pump intake is open. In this position, when the pump 216 is activated, the hydraulic fluid will circulate from the reservoir to the second chamber 506 (on the left of the piston 220). Pressure then builds up to move the piston 220 from its first position to the second position.

The hydraulic distributor 602 also has a bottom position. In the bottom position, the fluid path from the reservoir to the pump intake is closed, while the fluid path from the second chamber 506 (left of the piston 220) to the pump intake is open. The pump output is connected to the second part of the first chamber (right side of the piston 220) and the reservoir. As a result, when the pump is activated, the fluid will circulate from the second chamber 506 (left of the piston 220) to the reservoir, which creates a pressure drop in the second chamber 506. The pressure drop causes a differential pressure to develop across the piston 220, which moves the piston 220 back to its first position.

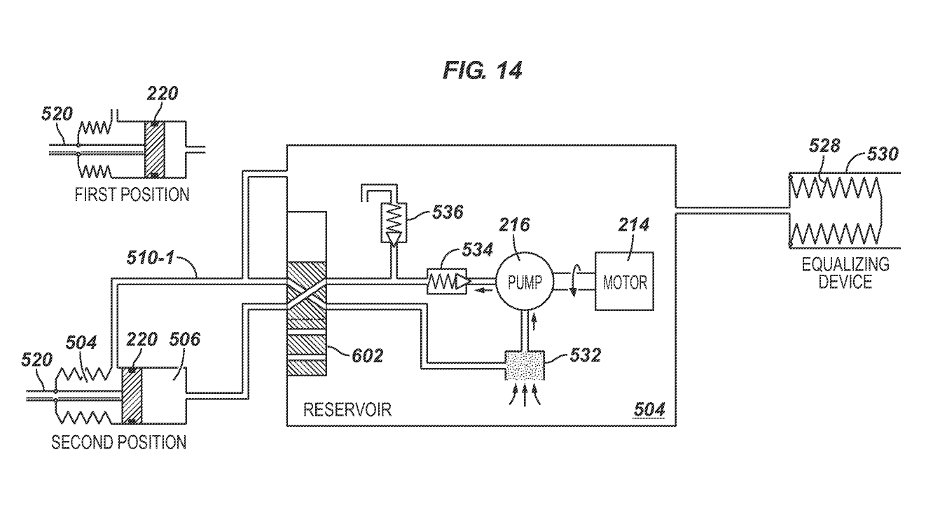

FIG. 14 depicts the hydraulic diagram of the arrangement of FIG. 13 that includes the hydraulic distributor 602.

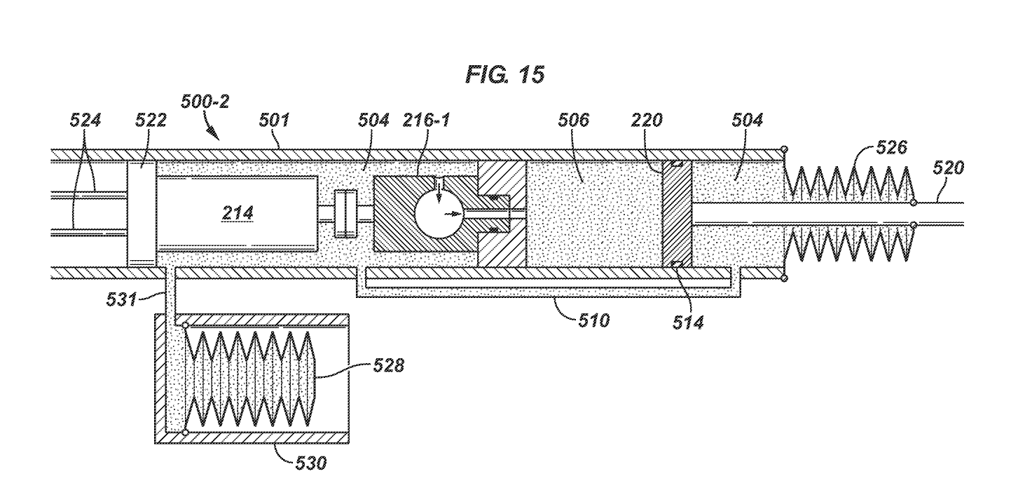

FIG. 15 depicts another example electro-hydraulic actuator 500-2. This electro-hydraulic actuator 500-2 uses a reversible pump 216-1. The electro-hydraulic actuator 500-2 does not include the tension spring 516 and valve 512 of FIG. 11, nor the hydraulic distributor 602 of FIG. 13.

When the reversible pump 216-1 flows from the first chamber 504 to the second chamber 506, this will over-pressurize the second chamber 506 to move the piston 220 from the first position to the second position.

On the other hand, when the pump flow is reversed, this will under-pressurize the second chamber 506 and make the piston 220 move from the second position to the first position.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. An apparatus comprising:
a circuit to receive power and data over a communication medium, the circuit to separate the power and the data; and
an electronic switch to couple the power output by the circuit to a downhole electrical component for use in a well, the downhole electrical component selected from the group consisting of a pump and an electro-hydraulic actuator.

2. The apparatus of claim 1, wherein the circuit includes a modulation transformer.

3. The apparatus of claim 1, wherein the circuit includes a demultiplexer to separate a first component having a higher frequency in a signal from a second component having a lower frequency in the signal.

4. The apparatus of claim 1, further comprising a telemetry module to receive the data output by the circuit.

5. The apparatus of claim 5, wherein an output of the telemetry module is connected to the electronic switch, the output to provide a command to the electronic switch to activate or deactivate the switch.

6. The apparatus of claim 1, wherein the electronic switch includes a semiconductor switch bidirectional (bilateral) triode thyristor.

7. The apparatus of claim 1, wherein the electronic switch includes a component selected from the group consisting of a bidirectional triode thyristor and a power transistor.

8. The apparatus of claim 1, further comprising a shared communication medium to communicate the power and data between the circuit and a surface unit located at an earth surface.

9. The apparatus of claim 8, wherein the shared communication medium comprises a medium selected from the group consisting of a twisted wire pair and a coaxial cable.

10. The apparatus of claim 8, wherein the shared communication medium is a first shared communication medium, the apparatus further comprising a second shared communication medium and an inductive coupler to inductive couple the power and data between the first and second shared communication media.

11. A system comprising:
a surface unit having a power supply and a telemetry module;
a downhole electrical module for positioning in a well; and
a shared communication medium to communicate power and data between the surface unit and the downhole electrical module,
wherein the downhole electrical module includes:
an electrical component selected from the group consisting of a pump and an electro-hydraulic actuator;
a circuit to receive the power and data over the shared communication medium and to separate the power from the data; and
an electronic switch to couple the power output by the circuit to the electrical component.

12. The system of claim 11, further comprising a second downhole electrical module that is connected to the shared communication medium, the second downhole electrical module including a second electrical component to be powered by the power communicated over the shared communication medium, the second electrical component being of a type different from the electro-hydraulic actuator.

13. The system of claim 11, wherein the shared communication medium is a first shared communication medium to which the downhole electrical module is connected, the system further comprising:
a second shared communication medium; and
an inductive coupler to inductively couple the power and data between the first and second shared communication media.

14. The system of claim 13, wherein the downhole electrical module and the first shared communication medium are for positioning in a lateral branch.

15. The system of claim 11, wherein the circuit includes a component selected from the group consisting of a modulation transformer and a demultiplexer.

16. The system of claim 11, wherein the electronic switch comprises a semiconductor switch.

17. An electro-hydraulic actuator for use in a well, comprising:
an outer housing defining a first hydraulic chamber and a second hydraulic chamber;
a piston;
a pump to apply fluid pressure to the second hydraulic chamber to cause movement of the piston from a first position to a second position; and
a first bellow to provide a fluid seal for the first hydraulic chamber from a well region outside the first hydraulic chamber without use of an elastomeric seal.

18. The electro-hydraulic actuator of claim 17, further comprising an actuator rod coupled to the piston, wherein the first bellow is welded to the actuator rod and to the outer housing.

19. The electro-hydraulic actuator of claim 17, further comprising a second bellow to provide an equalizing device for the first chamber, the second bellow to equalize a pressure between the first chamber and the well region outside the electro-hydraulic actuator.

20. The electro-hydraulic actuator of claim 17, further comprising a spring to bias the piston to the first position when pressures in the first and second chambers are balanced.

21. The electro-hydraulic actuator of claim 17, further comprising a hydraulic distributor having plural positions to control pressure in the first and second chambers.

22. The electro-hydraulic actuator of claim 17, wherein the pump is a reversible pump.
